(19) United States
(12) Patent Application Publication
(10) Pub. No.: US 2023/0146150 A1
(43) Pub. Date: May 11, 2023

(54) ELECTRONIC SYSTEM AND ELECTRONIC METHOD FOR CREATING ROYALTY STREAM POTENTIAL INVESTMENT PORTFOLIO DATA AND GRAPHICAL USER INTERFACE DISPLAYS BASED ON SEPARATE AND INDEPENDENT ENTERTAINMENT APPLICATION SYSTEM DATA

(71) Applicant: Harry L. Crisp, III, Franklin, TN (US)

(72) Inventor: Harry L. Crisp, III, Franklin, TN (US)

(21) Appl. No.: 18/051,628

(22) Filed: Nov. 1, 2022

Related U.S. Application Data
(60) Provisional application No. 63/263,727, filed on Nov. 8, 2021.

(51) Int. Cl. G06Q 40/06

(52) U.S. Cl. CPC G06Q 40/06

(57) ABSTRACT

An electronic system and an electronic method for creating royalty stream potential investment portfolio data from digital asset data from a digital asset management system and entertainment application system data from an entertainment system that is completely independent from the digital asset management system, and display indications of the royalty stream potential investment portfolio data to enable investments in digital assets.

### PRIORITY

This application claims priority to and the benefit of U.S. Provisional Patent Application No. 63/263,727, filed Nov. 8, 2021, the entire contents of which are incorporated herein by reference.

### BACKGROUND

Various electronic investment data systems are known. Various electronic entertainment data systems are known. Electronic investment data systems and electronic entertainment data systems have not been integrated in various manners such as described herein.

### SUMMARY

Various embodiments of the present disclosure provide an electronic system and an electronic method for creating and displaying royalty stream potential investment portfolio data based on completely separate and independent entertainment application system data. Various embodiments of the present disclosure provide electronic investment data systems that access certain electronic entertainment data systems associated with a user to obtain user selected entertainment related data to create and display investment related data associated with investment opportunities for the user (via graphical user display devices) that are based on the obtained user selected entertainment related data.

The present disclosure recognizes that content creators can generate digital assets (such as entertainment assets) that can provide royalty streams and that users (such as consumers) of those digital assets (such as entertainment assets) may want to invest in those royalty streams that arise from such digital assets (similar to how users invest in stocks that pay dividends). The present disclosure further recognizes that due to the relatively large quantity of content creators and different associated digital assets, it is currently technically difficult or impossible for an individual user (such as a consumer) to select such digital assets to invest in and determine how to invest in such digital assets (that the user has a personal interest in). The present disclosure addresses these technical problems in part by providing a technical solution that automatically identifies selected digital assets (such as entertainment assets) and automatically obtains entertainment related data that is related to such digital assets (such as by using the user's own electronic device(s)) and then employs that obtained entertainment related data to determine and display investment data related to the digital assets associated with the user selected entertainment related data from the many different available digital assets for the user to invest in. In various such embodiments, the electronic system thus seamlessly enables the user to view investment opportunity data associated with selected digital assets for possible investment and to select such investment opportunities. Responsive to the selection by the user of such one or more of such displayed investment opportunities, the electronic system facilitates such transactions and updates the user investment portfolio based on the selections made by the user—which are in part based on the user's own user selected entertainment data via independent entertainment systems.

Other objects, features, and advantages of the present disclosure will be apparent from the following detailed disclosure and accompanying drawings.

### BRIEF DESCRIPTION OF THE FIGURES

FIG. 1 is a perspective view of an electronic system for creating and displaying royalty stream potential investment portfolio data from separate and independent entertainment application system data in accordance with one example embodiment of the present disclosure.

FIG. 2 is a flowchart showing one method of operation of the electronic system for creating and displaying royalty stream potential investment portfolio data from separate and independent entertainment application system data in accordance with the example embodiment of FIG. 1.

FIG. 3 is a screen shot of an example graphical user interface providable to a user of the electronic system for creating and displaying royalty stream potential investment portfolio data from separate and independent entertainment application system data in accordance with the example embodiment of FIG. 1.

### DETAILED DESCRIPTION

While the systems, devices, and methods described herein may be embodied in various forms, the drawings show, and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

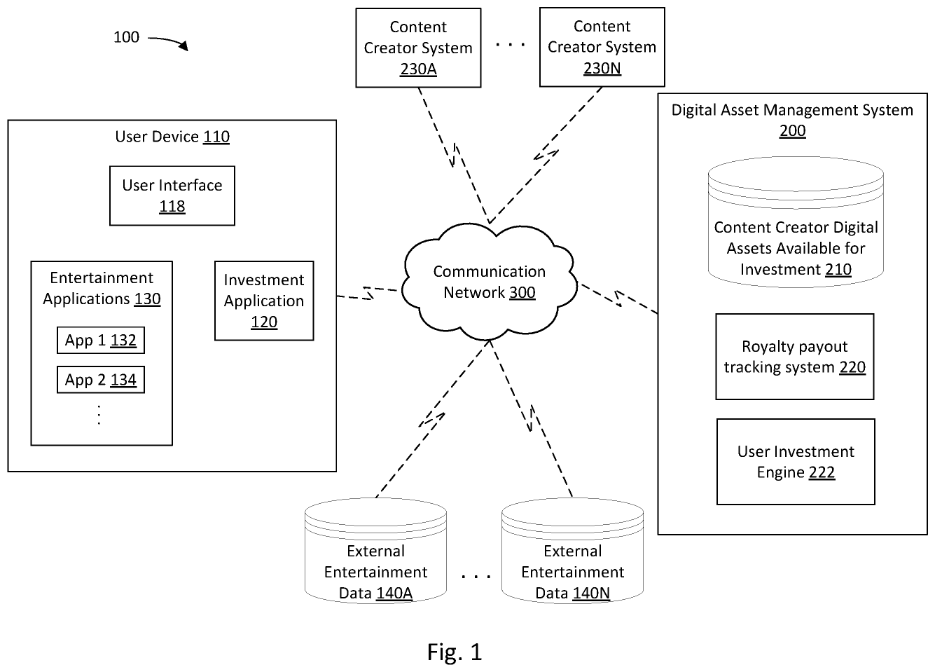

Turing now to the Figures, FIGS. 1, 2, and 3 illustrate an example electronic system for: (1) creating and displaying royalty stream potential investment portfolio data from separate and independent entertainment application system data; (2) enabling content creators to make royalty streams available for investment by users of the digital assets they create; and (3) employing such data to enable a user of the electronic system to invest in digital assets, in accordance with one example embodiment of the present disclosure. For brevity, the electronic system for creating royalty stream potential investment portfolio data from separate and independent entertainment application system data is referred to herein as the “electronic system.” For brevity, the method for creating and displaying royalty stream potential investment portfolio data from separate and independent entertainment application system data is referred to herein as the “electronic method.”

The example electronic system 100 illustrated in FIG. 1 includes: (1) one or more electronic user devices such as the electronic user device 110; (2) one or more external entertainment databases such as external databases 140A to 140N; (3) one or more digital asset management systems such as digital asset management system 200; and (4) one or more content creator systems such as content creator systems 230A to 230N. Each of these can be communicatively coupled to one or more of the others through one or more communication networks such as the example communication network 300. The electronic method employs these apparatus in the example manners described below in accordance with the present disclosure.

The electronic user device 100 of the illustrated example includes a user interface 118, an investment application 120, and one or more entertainment applications 130. It should also be understood that the electronic user device 110 includes one or more controllers, processors, memory, and/or communication hardware to enable the user device to store data, execute instructions, and communicate with other computing devices such as, for example, the digital asset management system 200. The electronic user device 100 can be any suitable user device such as but not limited to a mobile smartphone, a tablet computer or computing device, a desktop computer, or a laptop computer.

The user interface 118 of the user device 110 can be configured to display information to a user and/or to receive inputs from the user. For instance, the user interface can include a display screen for displaying images, speakers for emitting sounds, a haptic feedback system, and various other output mechanisms. The user interface 118 can also include one or more input mechanisms such as a touch screen, buttons, a microphone, and more.

The investment application 120 can comprise instructions and data stored on a memory of the user device 110. The investment application 120 can be configured to facilitate communication with one or more of the entertainment applications 130 and the electronic user device 110 to determine independent entertainment application system data. This independent entertainment application system data can comprise locally stored data or externally stored data related to, for example, the user's likes, dislikes, favorite songs, favorite artists, most played songs or artists, playlists, and various other data related to digital assets. The locally stored data can be accessed by the investment application 120 without the need to communicate via the communication network 130. The externally stored data (i.e., user data stored on external servers such as by Spotify, YouTube, etc.) can be accessed such as via communication network 300.

The investment application 120 can also be configured to communicate with one or more other computing devices, such as the digital asset management system 200. The investment application 120 can be configured to transmit various data to the digital asset management system 200, such as the independent entertainment application system data, other user preference data, and/or other digital asset related data that can be used by the digital asset management system 200 for various purposes, such as described herein

The entertainment applications 130 of the user device 110 can include any suitable applications configured to run on an electronic user device 100, and that can be used to determine the independent entertainment application system data, which can correspond to the user's digital entertainment preferences related to digital assets. For example, the entertainment applications can include: (1) music-based applications such as Spotify, Apple Music, Pandora, Tidal, and more; (2) video-based applications such as YouTube, TikTok, Snapchat, and more; and (3) other entertainment applications such as Facebook, Instagram, DraftKings, and more. Each of these entertainment applications can have associated independent entertainment application system data that corresponds to the user's interactions with the entertainment application, and which reflects the user's preferences. This data can be accessed by the investment application 120 and can be transmitted to the digital asset management system 200 for various purposes as described herein.

The external entertainment databases 140A to 140N includes databases configured to store data corresponding to the entertainment applications 130, but which is not stored by the electronic user device 110 itself. For example, an entertainment application such as Spotify can store some data locally (e.g., playlists, liked songs, etc.), while other data is stored on one or more external servers or databases (e.g., played songs, historical user data, etc.). This external data can be accessible via the communication network 300. In various example embodiments, the investment application 120 can communicate with the external entertainment data source directly, while in other example embodiments the investment application 120 can communicate via the entertainment applications 130 stored locally on the electronic user device 110. In other example embodiments, the data stored by the external entertainment data databases 140A to 140N can be accessible by the digital asset management system 200, without any communication passing through either the investment application 120 or the entertainment applications 130 of the electronic user device 110.

In various embodiments, the asset management system 200 can include one or more databases for storing content creator digital assets or references thereto available for investment 210, can include a royalty payout tracking system 220, and can include a user investment engine 222.

The asset management system 200 can include one or more processors and one or more memory devices that store a plurality of instructions executable by the one or more processors to perform the functions of the asset management system 200 described herein and/or other suitable or needed functions for implementing the electronic systems or electronic methods of the present disclosure.

In various embodiments of the present disclosure, each processor is a suitable processing device or set of processing devices, such as a microprocessor, a microcontroller-based platform, a suitable integrated circuit, or one or more Application-Specific Integrated Circuits (ASICs), configured to execute software enabling various tasks such as the tasks described herein.

In various embodiments of the present disclosure, each memory device includes one or more of the following: (1) volatile memory (e.g., RAM, which can include non-volatile RAM, magnetic RAM, ferroelectric RAM, and any other suitable forms); (2) non-volatile memory (e.g., disk memory, Flash memory, Erasable Programmable Read-Only Memory or “EPROMs”, Electrically Erasable Programmable Read-Only Memory or “EEPROMs,” memristor-based non-volatile solid-state memory, etc.); (3) unalterable memory (e.g., Programmable Read-Only Memory or “PROMs”); (4) read-only memory; and/or (5) a secondary memory storage device, such as a non-volatile memory device, configured to store software related information. Any other suitable magnetic, optical, and/or semiconductor memory can operate in conjunction with the present disclosure. Any suitable combination of one or more computer readable media can be utilized. The computer readable media can be a computer readable signal medium or a computer readable storage medium. A computer readable storage medium can be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a Random Access Memory (RAM), a Read-Only Memory (ROM), an erasable programmable read-only memory (EPROM or Flash memory), an appropriate optical fiber with a repeater, an optical storage device, a magnetic storage device, or any suitable combination of the foregoing. In the context of the present disclosure, a computer readable storage medium can be any tangible medium that can contain or store a program for use by or in connection with an instruction execution system, apparatus, or device.

It should also be appreciated that aspects of the present disclosure can be illustrated and described herein in any of a number of patentable classes or context including any new and useful process, machine, manufacture, or any new and useful improvement thereof. Accordingly, aspects of the present disclosure can be implemented entirely hardware, entirely software (including firmware, resident software, micro-code, etc.) or combining software and hardware implementation that can all generally be referred to herein as a “circuit,” “module,” “component,” or “system.” Furthermore, aspects of the present disclosure can take the form of a computer program product embodied in one or more computer readable media having computer readable program code embodied thereon. Computer program code for carrying out operations for aspects of the present disclosure can be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. It should further be appreciated that aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. These computer program instructions can also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions can also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The disclosure set forth in this paragraph can apply to any electronic part of the system of the present disclosure.

The content creator digital assets available for investment 210 are stored in a database configured to store digital assets created, generated, or provided by one or more of the content creator systems 230A to 230N. The digital asset management system 200 can communicate with the one or more content creator systems 230A to 230N such as via the communication network 300, for the purpose of receiving the digital assets created by the content creators, and/or relevant data to enable investment in the created digital asset (e.g., name, title, owner, and other identifying data used to track the digital assets). The database(s) of content creator digital assets available for investment 210 can additionally or alternatively include one or more lists of content creators, songs, music, lyrics, audio-visual works, videos, podcasts, and/or other types of digital assets that can be invested in. It should be appreciated that the use of the term digital assets includes content that is in digital or analog formats, but are suitably accessible via digital systems, and thus the term digital assets is not meant to exclude analog created content.

The royalty payout tracking system 220 enables investment in the digital assets stored or the list thereof stored in the database of content creator digital assets available for investment 210. The royalty payout tacking system 220 also: (1) enables trading in royalties and revenues (somewhat similar to trading stocks that have dividends); (2) enables fractional ownership of royalty streams in the digital assets in the database 210; and (3) enables users to build a portfolio of digital assets, trade digital assets, and invest money in the digital assets in exchange for partial ownership of royalty streams in those digital assets. The royalty payout tracking system 220 can store user profiles and/or content creator profiles. This enables the users to create and update their investment portfolios and enables the content creators to supply the digital assets for investment. In various example embodiments, the royalty payout tracking system 220 of the asset management system 200 can determine and track royalty performance of the digital assets available for investment 210. This tracking data can be used to make better recommendations to the user for which digital assets to invest in. The tracking data can be stored by the royalty payout tracking system 220. The royalty payout tracking system can also receive data from one or more other external sources such as via the communication network 300, including but not limited to SESAC (Society of European Stage Authors and Composers), BMI (Broadcast Music, Inc.), ASCAP (American Society of Composers, Authors, and Publishers), and the Harry Fox Agency.

The user investment engine 222 can be configured to communicate with various data sources and determine the royalty stream potential investment portfolio data. The user investment engine 222 can access the database of content creator digital assets available for investment 210, to determine which digital assets are available for investment. The user investment engine 222 can also access independent entertainment application system data (via communication over the communication network 300), which can comprise data from the investment application 120, the entertainment applications 130, and/or the external entertainment data 140A to 140N. The user investment engine 222 can then compare the content creator digital assets available for investment 210 to the independent entertainment application system data, to determine the royalty stream potential investment portfolio data corresponding to a particular user. The user investment engine 222 of the digital asset management system 200 can then communicate the royalty stream potential investment portfolio data to the user device 110, for the purpose of display to the user via the user interface 118 of the electronic user device 100 and possible selection by the user as investment opportunities.

The content creator systems 230A to 230N are configured to provide digital assets (represented by references thereto) to be invested in. The content creator systems 230A to 230N can be computing devices such as laptops, desktops, musical equipment, smartphones, tablets, and/or any other computing device configured to enable a content creator (such as an artist or musician) to generate a digital asset. These digital assets can include songs, videos, lyrics, audio-visual works, videos, and other digital assets that can provide a royalty stream to be invested in. These digital assets are then listed in the database of content creator digital assets available for investment 210 of the digital asset management system 200. In various example embodiments, the systems and methods of the present disclosure enable the content creators to sell full or partial ownerships of royalty streams in their created digital assets in exchange for up-front payments. Examples of such sales are provided below.

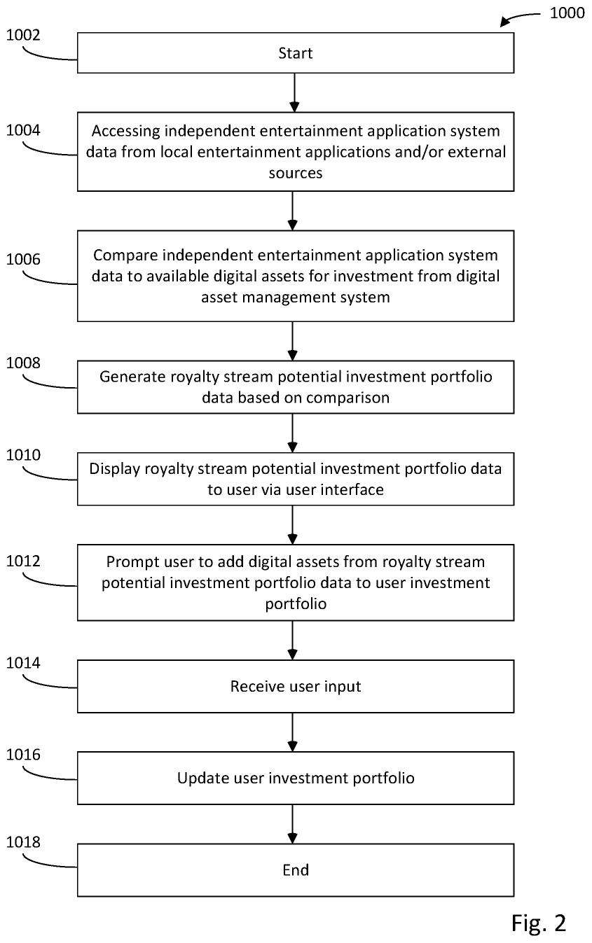

FIG. 2 illustrates an example electronic method 1000 that can be carried out by the electronic system disclosed herein. The steps of the electronic method 1000 are illustrated in a particular order, however it should be understood that various blocks can be added, removed, and/or reordered. In the illustrated embodiment, the electronic method 1000 starts at block 1002.

The electronic method 1000 includes accessing independent entertainment application system data from local entertainment applications and/or external sources, as indicated by block 1004. This can include the investment application running on the electronic user device accessing locally stored independent entertainment application system data from one or more entertainment applications stored by the electronic user device. It can also include the investment application communicating directly or indirectly with one or more external computing devices (e.g., servers) that can store the independent entertainment application system data. In one example embodiment, this includes the user investment engine 222 of the digital asset management system 200 communicating with the investment application 120 such as via the communication network 300, to retrieve the independent entertainment application system data.

The electronic method 1000 includes comparing the independent entertainment application system data to available digital assets for investment from the digital asset management system, as indicated by block 1006. This can include the user investment engine 222 accessing the content creator digital assets available for investment 210 of the digital asset management system 200, to retrieve a list of available digital assets. The user investment engine can then make a comparison and can rank the available digital assets based on various factors, such as but not limited to being based on which digital assets are most closely related to the independent entertainment application system data corresponding to the user. These factors can be any suitable factors including usage data (such as how many times a user listened or watched a digital asset of a content creator).

The electronic method 1000 includes generating royalty stream potential investment portfolio data based on this comparison, as indicated by block 1008. The royalty stream potential investment portfolio data can include a list or other structure of digital assets that are ranked or ordered based on the independent entertainment application system data. In one example embodiment, the user investment engine 222 of the digital asset management system 200 generates the royalty stream potential investment portfolio data.

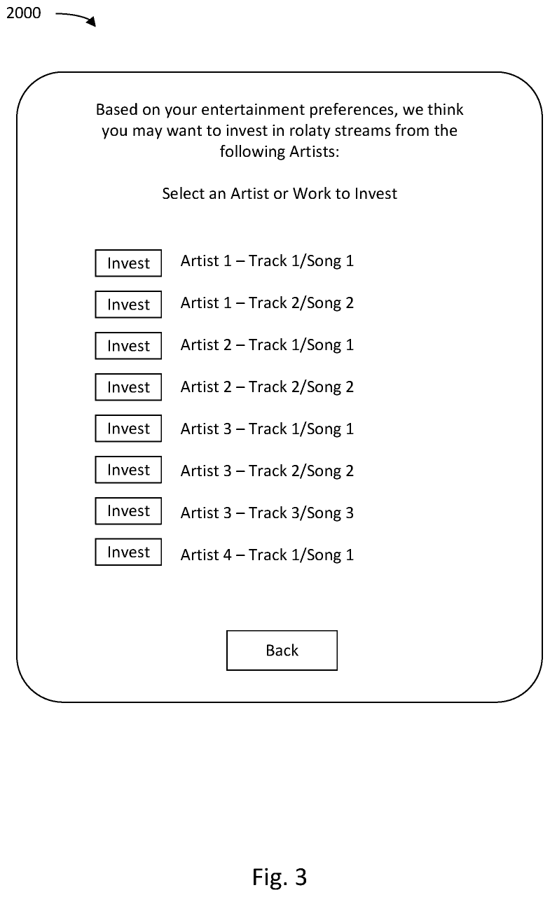

The electronic method 1000 includes displaying the royalty stream potential investment portfolio data to the user via the user interface of the user device, as indicated by block 1010. This can include the user investment engine 222 transmitting the royalty stream potential investment portfolio data to the electronic user device 110 such as via the communication network 300, and then the electronic user device 110 displaying the royalty stream potential investment portfolio data in the form of a list of digital assets to the user along with a prompt, such as in the example display shown in FIG. 3.

The electronic method 1000 includes prompting the user to add digital assets from the royalty stream potential investment portfolio data to a user investment portfolio, as indicated by block 1012. The prompt can indicate that the displayed digital assets of the royalty stream potential investment portfolio data are the most relevant digital assets to the user, and/or can include an indication of why these particular digital assets were selected and displayed (e.g., digital asset 1 was chosen based on your most listened to artist on Spotify). The displayed information can include all relevant information such as all financial terms for the transaction.

The electronic method 1000 includes receiving user input, as indicated by block 1014. This input can be one or more selections of one or more digital assets via the user interface, such as via tapping or clicking on the displayed digital asset.

The electronic method 1000 includes updating the user investment portfolio based on the user input, as indicated by block 1016. Where the user input includes a selection of a particular digital asset, the electronic method can include one or more follow up displays or questions requesting the user input an investment amount and/or other information. Once all the required information is received, the electronic system can facilitate the transactions and update the user's investment portfolio and take any other necessary actions (e.g., deducting the agreed value from a bank account, adding the selected digital asset to a list of digital assets owned by the user, updating the user profile stored by the royalty payout tracking system 220, etc.). The electronic method 1000 then ends as indicated by block 1018.

FIG. 3 illustrates an example display on a screen of an electronic user device 100 illustrating the royalty stream potential investment portfolio data. As shown, the display indicates that the listed digital assets of the royalty stream potential investment portfolio data were selected based on the user's entertainment preferences. The digital assets are listed in order according to the content create (i.e., the top two assets are from artist 1, the next two are from artist 2, etc.). However other arrangements or groupings can be used in accordance with the present disclosure. The displayed screen also prompts the user to select an artist or work to invest, requesting that the user select one or more of the displayed digital assets. When the user provides input via the user interface (e.g., selecting one or more of the “invest” icons), the display can change to a follow up screen requesting further information and to suitably facilitate the transaction. When the user selects “invest,” the electronic system can update the user's investment portfolio accordingly.

It should be appreciated from the above that various embodiments of the present disclosure provide electronic systems and electronic methods for enabling each of a plurality of users to invest in full or partial ownership of each of one or more royalty streams and/or revenue streams associated with each of one or more digital assets that include content created by user selected content creators (such as but not limited to the user' favorite media personalities, musicians, singers, actors, influencers, and the like). The electronic systems and methods also enable content creators to avoid reliance on traditional mechanisms for profiting from their creativity (e.g., record labels or other institutional bodies). The electronic systems and methods also enable an alternative where digital content creators instead trade full or partial ownership of the royalty or revenue streams of their digital assets for an immediate upfront payment (which is based on an investment by the user(s) of such digital assets).

The digital assets of all content creators who decide to take this non-traditional route can be combined into one or more databases of available digital assets for users to invest in. This enables the users to invest in the content they enjoy via full, partial, or fractional ownership of the royalty or revenue streams of digital assets that the user selects.

The electronic systems and electronic methods of the present disclosure thus access, obtain data from, and analyze the user's entertainment applications and data, to determine a set of content creators and digital assets that the user is likely to want to invest in, and provide mechanisms for the user to make such investments.

The following examples are provided as non-exclusive examples of how the electronic systems and methods of the present disclosure can be employed. These examples are not meant to limit the present disclosure.

In one example, the content creator is a well-known musical artist. The artist is willing to sell 10,000,000 investment units for $10 per unit to raise $100,000,000 in exchange for 25% of the royalty stream the artist receives from various digital assets owned by the artist for the remainder of the term of the copyright in the music. In this example, it is assumed that the artist owns all of the copyright rights to for the respective digital assets. In other examples, the artist could be replaced by the owner(s) or licensing entity of such copyright rights for such digital assets. In this example, the digital assets licensed include the rights to the music, lyrics and arrangements related video works, etc. In other examples, the digital assets could be limited to one or more of these components. In this example, the royalty stream revenue from the digital assets that the artist receives is $20,000,000 per year and thus each unit will have an annual expected revenue of $2. Thus, it will take 5 years for an investor to recoup the initial investments. In this example, since the content creator is a well-known artist and has an ongoing revenue stream, this investment has a lower amount of risk. In this example, the term of the royalty stream is unlimited in general duration, and this extends to at least the end of the copyright period for the digital assets. In other example embodiments, the term of the royalty stream could have a general duration such as 5, 10, 15, or 20 years. In this example, the electronic system of the present disclosure, and particularly, the user investment engine is configured to cause a display of the various components of this investment via a user access device.

In this example, the user investment engine is able to access user data to determine users that listen to this artist and thus which users may be more interested in making such investments in such digital assets. In this example, the user investment engine could access the user data regarding this artist from a third party application system such as Spotify (with the permission of the user) to analyze such data to make this determination and to display this investment opportunity to the user via the electronic user device. In this example, after the user invests in such digital assets, the user may be more likely to listen to such digital assets.

In another example, the content creator is an artist who is not well known. The artist is willing to sell 1,000,000 investment units for $0.05 per unit (to raise $200,000) in exchange for 50% of the royalty stream the artist receives from the digital assets. In this example, the term of the royalty is limited and particularly 20 years. Because the artist is not well known, the electronic systems and methods of the present disclosure provide multiple distinct advantages. The first advantage is to provide substantial funds for the artist. The second advantage is for the limited number of users that know of the artist and like the artist to invest in the digital assets of artist while the artist is not well known, with a potential upside on their investment in the digital assets of the artist. In this example, the electronic system of the present disclosure, and particularly, the user investment engine is configured to cause a display of the various components of this investment via a user access device.

In various embodiments of the present disclosure, the investment units are freely assignable. In various embodiments, the system can provide a mechanism for a user to sell such investments to enable user based on the date regarding the second user. In various embodiments, the investment units are not freely assignable, or not freely assignable for an initial period of time, or during certain periods of time.

As mentioned above, in various embodiments of the present disclosure, the digital assets can be works other than music, songs, lyrics, etc. In other embodiments, the digital assets can be movies, videos, audio visual works, etc. In other examples, the digital assets can be artwork, written works (such as books, stories, articles, etc.).

In various embodiments of the present disclosure, NFT contracts can be employed for the sales and purchases described herein.

In various embodiments of the present disclosure, the electronic system can be configured to create one or more records of the above-described transactions (such as royalty stream sales and purchase (whether or not embodied in NFT contracts) on a blockchain (such as via Solana, Etherium, etc.) to document ownership of the royalty string when the purchase is made. The electronic systems and electronic methods disclosed can be configured to support the creation of a blockchain that provides a forensic audit trail of anytime a royalty stream is bought or sold. In certain such embodiments, the blockchain can include a forensic record of any other data exchange or important action by the electronic system. In various embodiments, the blockchain is sharable among the n number of parties (or others) required to authorize an offer or sale, sale, or purchase with any discrepancy in the n number of parties holding copies of the blockchain resolved by utilizing the party that has the longest blockchain of record. In various embodiments, the blockchains can enable forensic audits based on the reverse unalterable nature of the blockchain. In various embodiments, the blockchains contain no sensitive data, and as such, the blockchains can be freely duplicated and distributed whenever needed.

In various embodiments, the electronic system and electronic method of the present disclosure includes suitable encryption systems that protect the communication or transfers of certain of the data employed by the electronic system and the method.

It should be appreciated that while the present disclosure references the works of the content creators as digital assets, such term is meant to include works that are created in analog form.

It should be appreciated from the above that various embodiments of the present disclosure provide an electronic system including a user investment engine configured to: (1) electronically access digital asset data from a digital asset management system; (2) electronically access entertainment application system data via an entertainment application on an electronic user device, the entertainment application being completely independent of the digital asset management system; (3) electronically generate royalty stream potential investment portfolio data based on the digital asset data and the entertainment application system data; (4) electronically transmit to the electronic user device, for the purpose of display by a user interface of the electronic user device, the royalty stream potential investment portfolio data; (5) electronically receive an instruction from the user device to add a digital asset indicated by the royalty stream potential investment portfolio data to a user investment portfolio associated with the user; and (6) responsive to the received instruction, electronically update the user investment portfolio.

It should further be appreciated from the above that various embodiments of the present disclosure provide an electronic system including a user investment engine configured to: (1) electronically access digital asset data from a digital asset management system; (2) electronically access entertainment application system data via an entertainment data system accessible by an electronic user device, the entertainment data system being completely independent of the digital asset management system; (3) electronically generate royalty stream potential investment portfolio data based on the digital asset data and the entertainment application system data; (4) electronically transmit to the electronic user device, for the purpose of display by a user interface of the electronic user device, the royalty stream potential investment portfolio data; (5) electronically receive an instruction from the user device to add a digital asset indicated by the royalty stream potential investment portfolio data to a user investment portfolio associated with the user; and (6) responsive to the received instruction, electronically update the user investment portfolio.

It should further be appreciated from the above that various embodiments of the present disclosure provide an electronic system including a user investment engine configured to: (1) cause a display, by a display device of an electronic user device, of an indication of royalty stream potential investment portfolio data determined based on (a) digital asset data from a digital asset management system and (b) entertainment application system data accessed from an entertainment application system used by an electronic user device and completely independent from the digital asset management system; (2) cause a display, by the display device of the electronic user device, of an indication of an instruction from to add a digital asset associated with the royalty stream potential investment portfolio data to a user investment portfolio; and (3) cause a display, by the display device of the electronic user device, of an indication to an update to the user investment portfolio.

Various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The claims are as follows:

1. An electronic system comprising:
a user investment engine configured to:
electronically access digital asset data from a digital asset management system;
electronically access entertainment application system data via an entertainment application on an electronic user device, the entertainment application being completely independent of the digital asset management system;
electronically generate royalty stream potential investment portfolio data based on the digital asset data and the entertainment application system data;
electronically transmit to the electronic user device, for the purpose of display by a user interface of the electronic user device, the royalty stream potential investment portfolio data;
electronically receive an instruction from the user device to add a digital asset indicated by the royalty stream potential investment portfolio data to a user investment portfolio associated with the user; and
responsive to the received instruction, electronically update the user investment portfolio.

2. An electronic system comprising:
a user investment engine configured to:
electronically access digital asset data from a digital asset management system;
electronically access entertainment application system data via an entertainment data system accessible by an electronic user device, the entertainment data system being completely independent of the digital asset management system;
electronically generate royalty stream potential investment portfolio data based on the digital asset data and the entertainment application system data;
electronically transmit to the electronic user device, for the purpose of display by a user interface of the electronic user device, the royalty stream potential investment portfolio data;
electronically receive an instruction from the user device to add a digital asset indicated by the royalty stream potential investment portfolio data to a user investment portfolio associated with the user; and
responsive to the received instruction, electronically update the user investment portfolio.

3. An electronic system comprising:
a user investment engine configured to:
cause a display, by a display device of an electronic user device, of an indication of royalty stream potential investment portfolio data determined based on (a) digital asset data from a digital asset management system and (b) entertainment application system data accessed from an entertainment application system used by an electronic user device and completely independent from the digital asset management system; and
cause a display, by the display device of the electronic user device, of an indication of an instruction from to add a digital asset associated with the royalty stream potential investment portfolio data to a user investment portfolio; and
cause a display, by the display device of the electronic user device, of an indication to an update to the user investment portfolio.
